(19) United States
(12) Patent Application Publication
(10) Pub. No.: US 2007/0192291 A1
(43) Pub. Date: Aug. 16, 2007

(54) Personal object work lists

(76) Inventors: Miro Vins, Schwetzingen (DE); Patrick Zimmer, Walldorf (DE)

Correspondence Address: MINTZ, LEVIN, COHN, FERRIS, GLOVSKY & POPEO, P.C., 9255 TOWNE CENTER DRIVE, SUITE 600, SAN DIEGO, CA, 92121, US

(21) Appl. No.: 11/345,874

(22) Filed: Feb. 2, 2006

(51) Int. Cl. G06F 17/30

(52) U.S. Cl. 707/3

(57) ABSTRACT

A method for creating a custom work list includes executing a query based on search criteria. Results of the query comprising at least one of a business object and a task conforming to the search criteria. The search criteria and the returned results are combined to create said custom work list.

### BACKGROUND

1. Technical Field

The present disclosure relates to work lists and, more specifically, to personal object work lists.

2. Description of the Related Art

Enterprise Resource Planning (ERP) applications are geared towards integrating information relating to a diverse set of business applications into a singular database. One prime example of an ERP solution is “mySAP” or “SAP R/3” offered by SAP.

Modern ERP applications, such as mySAP, allow for users to interact with the singular database via one or more web-based portals that are specifically tailored to the needs of the particular user. While accessing one such portal, a user may generate one or more reports. A user may generate a report using data from the database. For example, a sales representative may be interested in knowing what sales orders are pending for a particular customer. To make this determination, the sales representative may generate a report on all pending sales orders for that particular customer.

Conventionally, the process of generating a report can be complicated and require special skills. For example, the process for generating a report may look and feel different for different reports. It can therefore be difficult and time consuming for a user to learn how to generate each type of report that the user may wish to generate. Moreover, each time the user wishes to generate the same report, the whole process must be redone.

For example, if the sales representative frequent calls from the same customer asking how many sales orders are pending for that customer, the sales representative will have to generate the report, wait for the results, and count the number of results that are returned. This process will have to be repeated each time the customer calls.

Because generation of reports can be complex, time consuming and require specialized skills, organizations must devote substantial resources for training and using ERP systems.

Therefore, a method and system is desired for the fast and simple generation and utilization of database reports in an ERP environment.

### SUMMARY

A method for creating a custom work list includes executing a query based on search criteria. Results of the query comprising at least one of a business object and a task conforming to the search criteria. The search criteria and said returned results are combined to create said custom work list.

A graphical user interface for creating a custom work lists includes a receiving screen for receiving search criteria. An execution indicator indicates that a query based on said search criteria is executing. A custom work list display screen displays one or more work lists formed from combining the search criteria and search results from the executed query.

A computer system includes a processor and a program storage device readable by the computer system, embodying a program of instructions executable by the processor to perform method steps for creating a custom work list. The method includes executing a query based on search criteria. Results of the query comprising at least one of a business object and a task conforming to the search criteria. The search criteria and said returned results are combined to create said custom work list.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a flow chart showing the generation of a custom work list according to an embodiment of the present disclosure;

FIG. 2 is a screenshot showing a POWL define a new query screen according to an embodiment of the present disclosure;

FIG. 3 is a screenshot showing a POWL define new query attributes screen according to an embodiment of the present disclosure;

FIG. 4 is a screenshot showing a POWL define new query finish screen according to an embodiment of the present disclosure;

FIG. 5 is a screenshot showing a POWL Personalization screen according to an embodiment of the present disclosure;

FIG. 6 is a screenshot showing a POWL advanced list viewer setting screen according to an embodiment of the present disclosure;

FIG. 7 is a screenshot showing a POWL Personalization-Layout switch screen according to an embodiment of the present disclosure;

FIG. 8 is a screenshot showing a POWL in Link Matrix layout screen according to an embodiment of the present disclosure;

FIG. 9 is a screenshot showing a POWL in tab strip layout screen according to an embodiment of the present disclosure;

FIG. 10 is a screenshot showing a POWL query refresh screen according to an embodiment of the present disclosure;

FIG. 11 is a screenshot showing a POWL refresh all queries start screen according to an embodiment of the present disclosure;

FIG. 12 is a screenshot showing a POWL refresh all queries pending screen according to an embodiment of the present disclosure; and

FIG. 13 shows an example of a computer system capable of implementing the method and apparatus according to embodiments of the present disclosure.

### DETAILED DESCRIPTION

In describing the preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Embodiments of the present disclosure use work lists in place of reports. A work list may be a database report relating to one or more business objects that is cached in the database so that once generated, the work list may be easily updated. The work lists of the present disclosure provide many advantages over conventional reports. For example, work lists are enduring. After a work list has been generated, it may persist on the user's account for later reference. The work list may then be updated, either on demand, or periodically. For example, a sales representative may generate a work list pertaining to pending sales orders for a given customer. That work list may then persist on the sales representative's account. Then each day the customer calls to enquire about the number of pending sales orders, the sales representative may simply refer to the generated work list that has been automatically updated the previous evening.

Embodiments of the present disclosure may allow a user to view their collection of generated work lists, for example, through a web-based portal. The user may be provided with an inbox of work lists that each indicate the number of results within the work list. For example, the sales associate may see “Customer's Pending Sales Orders (14)” and know that the customer has 14 pending sales orders with minimal effort. The user may then have the opportunity to explode the desired work list to obtain additional details, for example, the sales objects, in this case sales orders, that comprise the work list. In this way, work list management is both simple and quick.

Moreover, all types of work lists may be generated through a common user interface so that the user encounters a familiar look and feel for each type of work list the user may be interested in generating. In this way, work list generation may be kept as simple as possible.

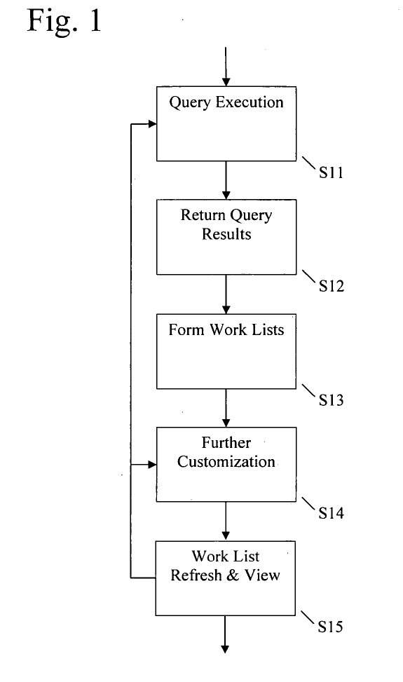

According to embodiments of the present disclosure, users may define work lists that are personally customized (custom work lists). FIG. 1 is a flow chart showing the generation of a custom work list according to an embodiment of the present disclosure. The generation of custom work lists may begin with the user executing a query based on one or more search criteria (Step S11). The search criteria may be used to determine one or more attributes of the desired custom work list. When the query is executed, query results may be returned (Step S12). The query results may include one or more business objects and/or tasks that conform to the search criteria. The combination of the query and the query results may form the work list (Step S13). Work lists may be further customized by including one or more editable work list lines, for example, input fields, dropdown menus, checkboxes, etc. The user may use the editable work list lines to perform quick changes to the respective work items (Step S14).

Further customization may include additional filtering, the removal of one or more columns, creation and/or addition of queries, change of layout, change of column order, change of filtering and/or filter values. The work lists may be fully editable by the user.

After the work list has been generated, the work list may be refreshed and viewed (Step S15). For example, the work list may be automatically refreshed each evening. Further customization (Step S14) may be conducted at any point thereafter, and the customizations will persist when the work list is refreshed or viewed (Step S15). Additionally, the user may thereafter modify the work list query thereby re-executing the work list from the beginning (Step S11).

As described above, work lists may be defined by customizing values for a subset of selection parameters of the respective query. The query results may be updated as desired. Updating the query results is comparable to re-executing the query. This may be advisable when the database has been updated and the query results may have changed. Updating the queries/work lists may also be performed periodically, for example, by the system administrator. For example, the system administrator may update query results at a time when the database server load is likely at a minimum, for example at night. Additionally, the user may independently initiate an update of one or more queries/work lists as desired.

As described above, work lists may include business objects. Business objects are documents build around database entries that serve some particular business purpose. For example, a purchase order may be considered a business object.

Work lists may be displayed via a user interface. For example, a web-based user portal may be used to display the work lists. Personal Object Work List (POWL) is one example of a web-based user portal that may be used to present work lists to a user. POWL allows for the simultaneous display of multiple work lists. For example, multiple work lists based on different business objects may be displayed side-by-side so that the user may easily switch between them. Additionally, an efficient caching mechanism based on cluster tables may be implemented to assure work list switching regardless of the sizes of the corresponding work lists.

The user portal may include a graphical user interface that is highly suited for managing a work list environment. For example, an Advanced Business Application Programming (ABAP) based user interface framework, may be utilized for programming the desired graphical user interfaces.

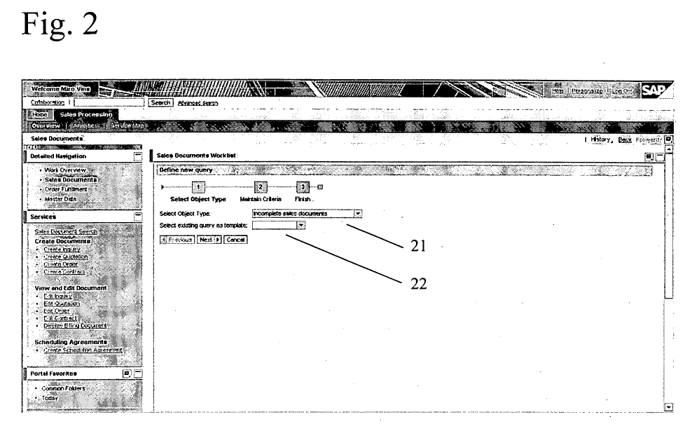

FIGS. 2-4 are screenshots for describing how a custom work list is created. FIG. 2 is a screenshot showing how a POWL is used to define a new query screen according to an embodiment of the present disclosure. First, the object type of the work list may be selected. For example, a “select object type” dropdown menu 21 may be used to select the desired object type. The object type defines the characteristics of the work list. By choosing an object type, the user may choose the type of custom work list the user intends on creating. The object types may be defined in the database. The types of parameters that the user is asked to supply may be based on the selected work list and thus, the object type definition may include one or more corresponding parameters.

Where a user wishes to generate a new work list based on a previously existing work list, the user can select an existing work list/query as a template for the forming of a new work list. For example, a “select existing query as template” dropdown menu 22 may be used to select an existing query to be used as a template.

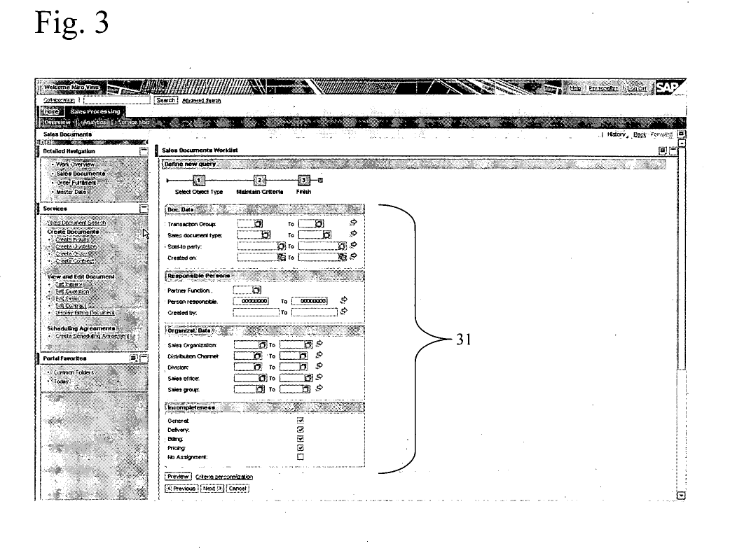

FIG. 3 is a screenshot showing a POWL define new query attributes screen according to an embodiment of the present disclosure. After the object type has been selected (FIG. 2), the user may be asked to enter the query parameters. For example, a set of text entry boxes 31 may be used to facilitate the entry of query parameters. The query parameters may be the criteria by which the user intends on generating the custom work list. It also may be the search criteria for executing the query. When using a graphical user interface, the interface may be automatically customized to receive the desired parameters. The user may thus be prompted to enter the desired parameters.

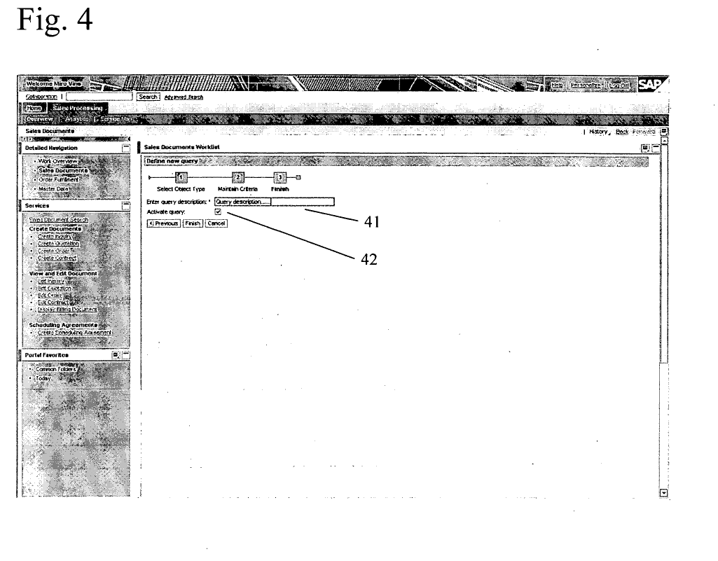

FIG. 4 is a screenshot showing a POWL define new query finish screen according to an embodiment of the present disclosure. After the parameters have been entered (FIG. 3), the user may be asked to provide some description and categorization information. For example, the user may provide a description of the work list so that it may be easily identified. For example, an “enter query description” text entry box 41 may be used to facilitate entry of the query description. The work list may also be assigned to a work list category. The work lists may be hierarchically categorized to facilitate work list selection. Work list categories may be created, deleted and modified by a user and/or administrator and work lists may be reassigned to another category.

The user may also specify whether the work list being created is an active query or an available query. The user may, for example, specify that the query is active by checking an “active query” check box 42. If the work list is an active query then it may be prominently featured in the user's portal. For example, that work list may be listed in a listing of active work lists presented to the user on sign in. Available queries may be work lists that have been created but have not been specified as active. A user can navigate to a listing of available queries. Here a user may view the available queries and/or activate an available query.

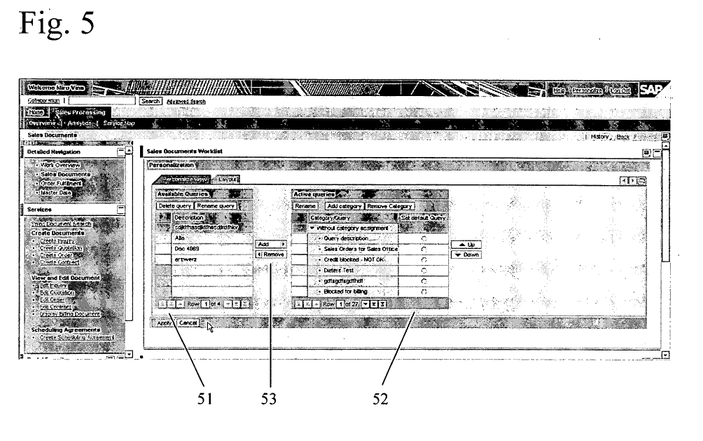

FIG. 5 is a screenshot showing a POWL Personalization screen according to an embodiment of the present disclosure. This screenshot provides an example of how active and available queries may be managed. A user may navigate to such a screen to add an available query to the listing of active queries and/or remove an active query to the listing of available queries. For example, a user may be shown a listing of available queries 51, a listing of active queries 52 and a set of “add and remove” buttons 53 for adding a query from the listing of available queries 51 to the listing of active queries 52 and/or removing a query from the listing of active queries 52 to the listing of available queries 51. The user may also reorder active queries so that they may occupy a more or less prominent position in the user's portal. A user may also choose to set one active query as a default query. The default query may be automatically selected when the POWL user portal is started.

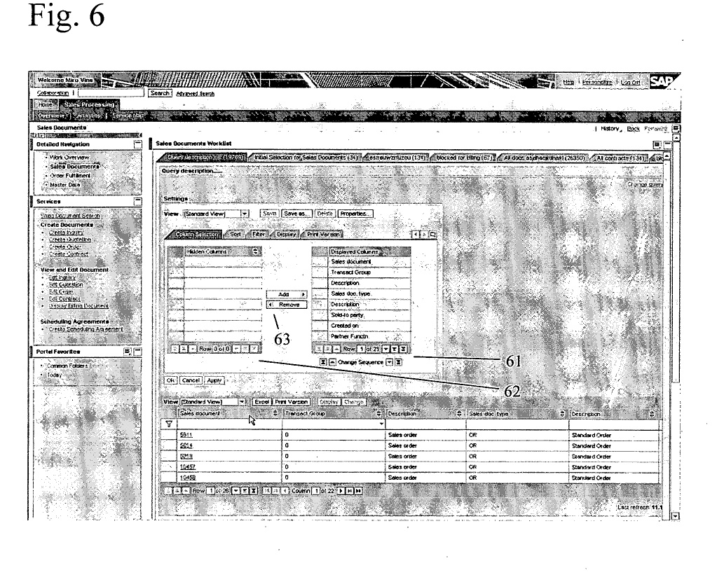

FIG. 6 is a screenshot showing a POWL advanced list viewer setting screen according to an embodiment of the present disclosure. This screenshot provides an example of how a user may customize the layout of the work lists on the user's portal. The user may use such a screen to customize the layout, for example, to sort, hide or display columns, or otherwise manage the presentation of the work lists. For example, a user may select a column of a query to be displayed or hidden. For example, a listing of columns to be displayed 61 may be presented along with a listing of columns to be hidden 62. A set of add/remove buttons 63 may be used to add a column from the listing of hidden columns 62 to the listing of displayed columns 61 and/or to remove a column from the listing of displayed columns 61 to the listing of hidden columns 62.

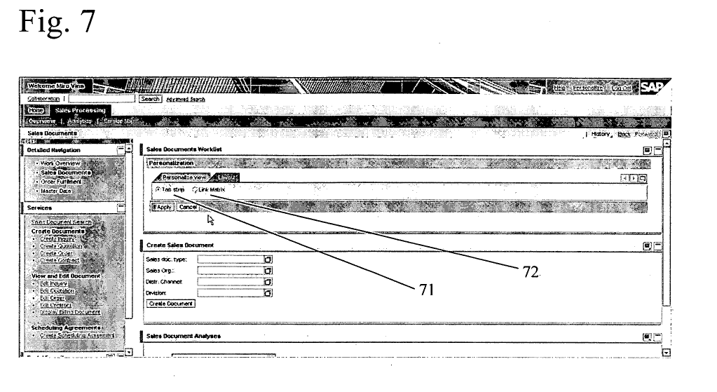

FIG. 7 is a screenshot showing a POWL Personalization-Layout switch screen according to an embodiment of the present disclosure. This screenshot provides an example of how a user may switch between multiple available layout styles. For example, a user may switch between a tab strip layout and a link matrix layout by selecting between a tab strip checkbox 71 and a link matrix check box 72.

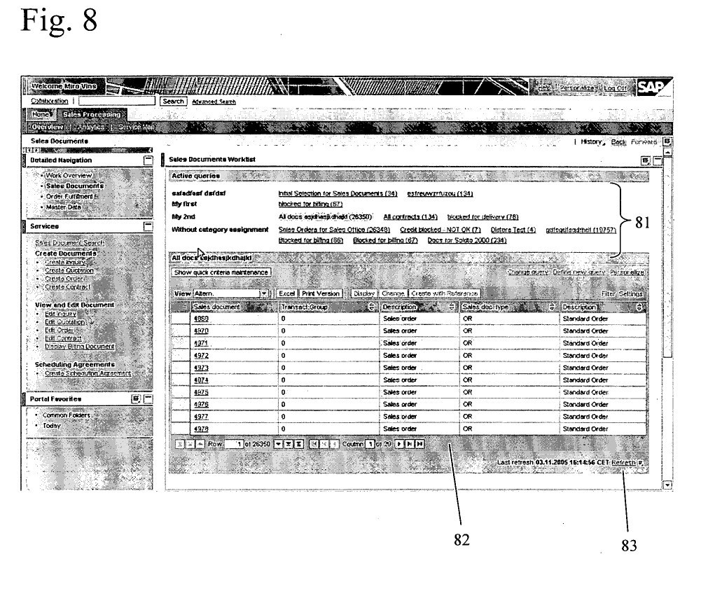

FIG. 8 is a screenshot showing a POWL in Link Matrix layout screen according to an embodiment of the present disclosure. This screenshot provides an example of a link matrix layout according to an embodiment of the present disclosure. In the link matrix layout, the user may be presented with links to all active queries 81. Selecting the desired active query may call up the relevant work list 82. For example, the list of active queries may be presented in a top pane 81 while the presented work list may be presented in a bottom pane 82. The last time and date of update (refresh) may be presented as well for the presented work list and the user may be given an opportunity to update the query from the same screen, for example, by selecting a “refresh” button 83.

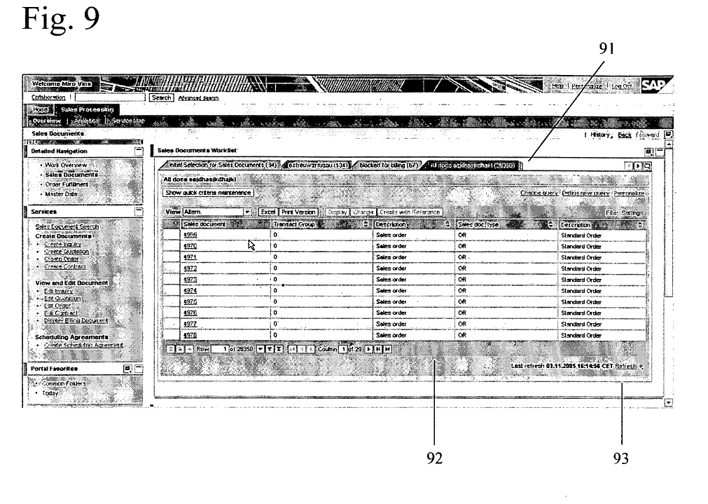

FIG. 9 is a screenshot showing a POWL in tab strip layout screen according to an embodiment of the present disclosure. In such a screen, for example, the selection of active queries may be presented as a row of selectable tabs 91 while the presented work list may be presented in a bottom pane 92. The last time and date of update (refresh) may be presented as well for the presented work list and the user may be given an opportunity to update the query from the same screen, for example, by selecting a “refresh” button 93.

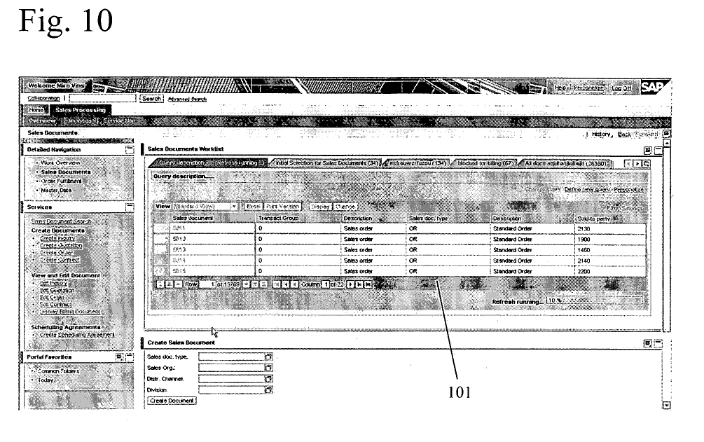

FIG. 10 is a screenshot showing a POWL query refresh screen according to an embodiment of the present disclosure. In such a screen a user may select to refresh (update) one or more work lists. For example, all work lists may be refreshed. Refreshing a work list would be comparable to re-executing the associated query. Work lists may be refreshed asynchronously, for example, in the background, so that the user may continue to interact with the user interface while the refresh(es) are being performed. A completion bar 101 may be presented to show the refresh progress, for example, what percentage of the refresh has been completed.

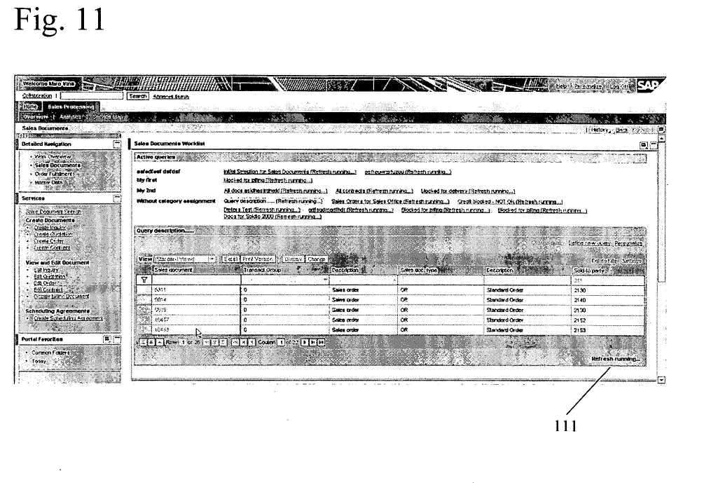

FIG. 11 is a screenshot showing a POWL refresh all queries start screen according to an embodiment of the present disclosure. The user may use such a screen to select a particular work list for refresh or to refresh all work lists. A “refresh running” indicator 111 may be displayed, for example, to indicate that a refresh is running.

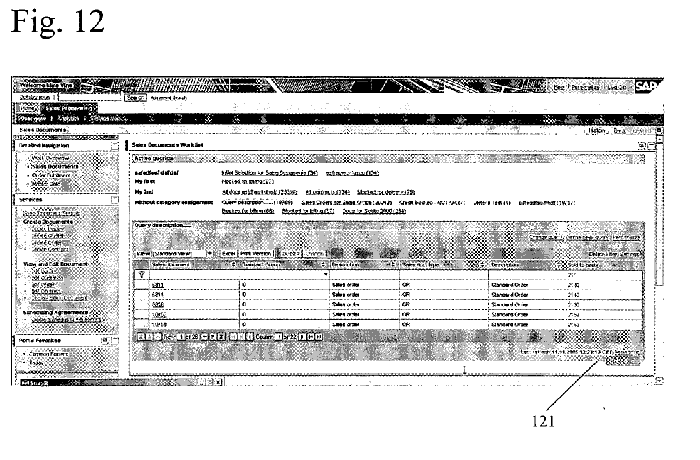

FIG. 12 is a screenshot showing a POWL refresh all queries pending screen according to an embodiment of the present disclosure. The user may encounter such a screen to select that all active queries be refreshed. A “last refresh” indicator 121 may be displayed, for example, to indicate the last time that a refresh has been run.

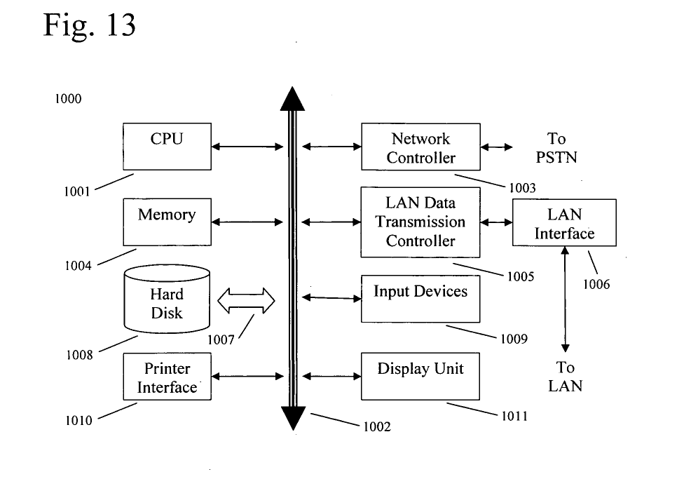

FIG. 13 shows an example of a computer system which may implement the method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

What is claimed is:

1. A method for creating a custom work list, comprising:
executing a query based on search criteria;
returning results of said query comprising at least one of a business object and a task conforming to said search criteria;
combining said search criteria and said returned results to create said custom work list.

2. The method of claim 1, additionally comprising further customizing said custom work list.

3. The method of claim 1, wherein said custom work list may be updated, wherein said updating comprises re-executing said query.

4. A graphical user interface for creating a custom work lists, comprising:
a receiving screen for receiving search criteria;
an execution indicator for indicating that a query based on said search criteria is executing;
a custom work list display screen for displaying one or more work lists formed from combining said search criteria and search results from said executed query.

5. The graphical user interface of claim 4, wherein said graphical user interface is or is part of a web-based portal.

6. The graphical user interface of claim 4, wherein said graphical user interface simultaneously displays one or more work lists.

7. The graphical user interface of claim 4, wherein one or more active work lists are presented are presented to a user more prominently than one or more available work lists.

8. The graphical user interface of claim 4, wherein displayed work lists may be displayed along with a graphical element for updating one or more of the displayed work lists.

9. The graphical user interface of claim 4, wherein one or more management screens may be used to manage created work lists.

10. A computer system comprising:
a processor; and
a program storage device readable by the computer system, embodying a program of instructions executable by the processor to perform method steps for creating a custom work list, the method comprising:
executing a query based on search criteria;
returning results of said query comprising at least one of a business object and a task conforming to said search criteria;
combining said search criteria and said returned results to create said custom work list.

11. The computer system of claim 10, additionally comprising further customizing said custom work list.

12. The computer system of claim 10, wherein said custom work list may be updated, wherein said updating comprises re-executing said query.
